(19) United States
(12) Patent Application Publication
(10) Pub. No.: US 2006/0063581 A1
(43) Pub. Date: Mar. 23, 2006

(54) Gaming system and game with player reward display

(76) Inventors: Ronnie W. Harris, Grove, OK (US); Ted Grav, Vancouver (CA)

Correspondence Address: WEIDE & MILLER, LTD., 7251 W. LAKE MEAD BLVD., SUITE 530, LAS VEGAS, NV, 89128, US

(21) Appl. No.: 11/089,340

(22) Filed: Mar. 23, 2005

Related U.S. Application Data
(63) Continuation-in-part of application No. 10/901,014, filed on Jul. 28, 2004.
Application No. 10/901,014 is a continuation-in-part of application No. 10/892,692, filed on Jul. 16, 2004.

(51) Int. Cl. A63F 13/00

(52) U.S. Cl. 463/16

(57) ABSTRACT

In a method of game play, a player is presented one or more games, such as upon placing a wager. The player may be awarded credits or monetary value for game wins. The player may also be awarded rewards credits or points, such as for wagers placed, games played, or for game outcomes. Reward information comprising a number of awarded points or awards representative of awarded points is displayed and preferably updated when points are awarded or used. Reward information may be modified when the denomination of wagers for game play changes. Reward information may be associated with a player, such as by storage in a file accessible with player identification information. One embodiment of the invention comprises gaming machines and gaming systems configured to display reward information.

### RELATED APPLICATION DATA

This application is a continuation-in-part of U.S. application Ser. No. 10/901,014, filed Jul. 28, 2004, which is a continuation-in-part of U.S. application Ser. No. 10/892,692, filed Jul. 16, 2004.

### FIELD OF THE INVENTION

The present invention relates to game play of wager type games and, more particularly, to a method of awarding wins and displaying winning results.

### BACKGROUND OF THE INVENTION

Federal laws define several types of gaming. One type is known as Class II gaming, and another is Class III gaming. While the statutory definition of Class III games does not include a specific definition of the games (the statutory definition is that Class III games are all games which are not Class I or II games), Class III games are generally recognized as being of the type commonly offered in casinos in Nevada, such as slot machines, video poker machines and the like.

According to the statutory definition, Class II gaming includes the game of chance commonly known as bingo, whether or not electronic, computer or other technologic aids are used in connection therewith. 25 U.S.C. § 2703(7). In accordance with statutory definition and interpretation thereof, the game of bingo requires multiple players to cover number or other designations on a card, and at least one winner comprising the player(s) who are the first to achieve a designated cover arrangement.

Class II gaming is very important and there is a strong desire for Class II games. Among other things, the Indian Gaming Regulatory Act (25 U.S.C. § 2701 et. seq.) provides that an Indian tribe may engage in Class II gaming where the state in which it is located permits similar games and such gaming is not otherwise specifically prohibited on Indian lands by Federal law. 25 U.S.C. § 2710(b)(1)(A). Thus, in accordance with this Act, though Class III gaming may be prohibited in certain locations, at those same locations, Class II games may be permitted. As a result, there is a substantial desire to produce, and a substantial demand for, Class II games.

Of course, the definition of Class II gaming is limited, and does not, even under the above-referenced exemption, allow the offering of slot, video poker and similar Class III games which are very popular. In order to make Class II gaming more exciting, many have sought ways to display the outcome of a Class II game.

As one attempt to create a Class II game having an outcome displayed as a secondary event, Class II games have been developed where the outcome of the bingo game is displayed as a simple slot-type graphic or display. Table I below details an example mapping of bingo game outcomes to slot game graphics or displays.

TABLE I

| Bingo Pattern | Prize Value | Slot Display | Description |
|---|---|---|---|
| 1 | 500 | R7-R7-R7 | 3 Red Sevens |
| 2 | 250 | W7-W7-W7 | 3 White Sevens |
| 3 | 100 | A7-A7-A7 | Any 3 Red or White Sevens |
| 4 | 50 | 3B-3B-3B | 3 Triple Bars |
| 5 | 30 | 2B-2B-2B | 3 Double Bars |
| 6 | 20 | 1B-1B-1B | 3 Single Bars |
| 7 | 10 | 3 CH | 3 Cherries |
| 8 | 5 | Any 3 1B,2B or 3B | Any 3 Single Double or Triple Bar |
| 9 | 5 | Any 2 R7 | Any 2 Red Sevens |
| 10 | 4 | Any 2 CH | Any 2 Cherries |
| 11 | 3 | Any 1 R7 | Any 1 Red Seven |
| 12 | 2 | Any 1 CH | Any 1 Cherry |

In accordance with this arrangement, if a player receives a bingo game winning outcome, such as Bingo Pattern No. 1 (this pattern might comprise, for example, a match of the number at all four corners of a player's card), then a graphic of the symbols Red 7-Red 7-Red 7 may be displayed. Thus, as part of the game, the gaming machine might display a video slot-type graphic or event in which graphically displayed reels stop and display the result Red 7-Red 7-Red 7. The player may be provided with a paytable indicating that this slot result has an associated payout of 500 credits. In this manner, while the player is playing a bingo game and the outcome of that game determines the actual award to which the player is entitled, the game may include a secondary event or display.

Unfortunately, this approach has several problems. A primary problem is that this arrangement does not permit an effective representation of the slot-type event or graphic to the actual Class II game outcomes. Slot game players are familiar with the odds of receiving winning and losing results for those games, for example. In order to replicate the “feel” of a slot-type event as the secondary display or graphic, the outcomes of the Class II game should cause the display of secondary events or graphics mimicking the play of a real game. In other words, displaying the outcome of the Class II game as a secondary event is not as exciting to the player when the displayed results are predictable and do not emulate the actual game which is being represented by the secondary event or display. Where the mapping is, as indicated above, provided on a one-to-one basis, this is problematic.

In addition, Class III games generally permit players to place wagers of different amounts, and the payouts and hit frequencies of winning results may change. For example, a player who places a two credit wager (vs. a one credit wager) may expect to receive less frequent winning results, but much higher payouts for those winnings results. The above-described mapping arrangement does not effectively provide for the simulation of this Class III game feature as the “display” of the Class II game outcome.

Currently, players of games, including Class II and Class III games, may be provided awards to entice them to play games. For example, a player may be awarded complimentary awards (“comps”), such as free or reduced cost meals or goods. Comps are often awarded in exchange for a player signing up for a casinos' player tracking system which enables the casino to track the player's game play and target advertising and offers to the player to entice them to play games at the casino. An improved reward system is desired, however, which is more effective in linking awards with game play and enticing player play, is desired.

### SUMMARY OF THE INVENTION

The invention comprises methods of playing/presenting a game and generating and displaying reward information, as well as gaming machines and gaming systems configured to present one or more games and generate, store and display reward information.

In one embodiment of the invention, one or more games are presented to a player. Preferably, a player places a wager, such as of one or more credits, to play each game. Game information or data is generated and the one or more games are presented to the player, such as including displaying game information to the player via a display of a gaming machine. In one embodiment, credits may be awarded, such as for a winning game outcome. Preferably, reward points or credits are also awarded at one or more times. The reward points or credits may be awarded under various circumstances, such as for game play, wagered amounts or as part of a game win payout.

In one embodiment, primary credits are used to make wagers and form the primary payout for winning game results. Secondary credits are also awarded, such as for winning game results. Preferably, the secondary credits have a fractional value, such as 1/100th, of each primary credit.

In accordance with the invention, reward information is displayed to the player. This information may include a numerical value regarding a number of awarded points. In one embodiment, points may have one or more representative awards, and the reward information may instead or additionally comprise information regarding representative awards, such as a number of free games or spins.

Preferably, the reward information is displayed continuously or frequently so that the status of awards is readily known to the player. By continuously displaying the reward information, for example, the player is immediately apprized of increases in rewards points for game play, thus enticing further game play. The player is also apprized of the “value” of the awards, such as free game play resulting from the award of the reward points.

In one embodiment, the value of rewards points may be tied to the denomination of wager for play of a game from which they were awarded. Thus, when a player plays a game of a different denomination, the number of points or awards may be automatically modified. For example, if a player accrues sufficient player points for a free game while playing a $1.00 denomination game, then if the player starts playing a $0.25 denomination game, the player's award may be increased to four (4) free games. Similarly, the number of points accrued my be modified. Of course, points and awards may be decreased when the player starts playing a higher denomination game.

In one embodiment, rewards points or awards are associated with a gaming machine. In such an embodiment, points and awards accrue and must be used at a single machine. If, for example, a player reaches a level of points for a free game, the player must play that free game or if the player leaves the machine, the next player is entitled to do so.

In another embodiment, rewards points or awards are associated with a player. For example, a player may be part of a player rewards system and be identified with player identification information. Awarded points or awards are preferably associated with the player, such as stored in a filed and assessed using the player's identification information. In this manner, a player can move from one machine to the next and accrue or use points/awards.

In an embodiment where rewards points are converted to representative awards, a visual indicator may be provided to the player regarding “how close” then are to the next award and when they have reached the next award. For example, a graphical display may be provided which indicates the “level” of points currently awarded to the player relative to the number necessary to reach the next award. A graphical or other indicator may also alert the player when the player has accrued sufficient points for an award, and to a reduction of the number of accrued points and increase in the number of awards.

Other embodiments of the invention comprise gaming machines and gaming systems for implementing this embodiment of the invention.

Further objects, features, and advantages of the present invention over the prior art will become apparent from the detailed description of the drawings which follows, when considered with the attached figures.

### DESCRIPTION OF THE DRAWINGS

FIG. 1 illustrates a gaming machine in accordance with one embodiment of the invention;

FIG. 2 illustrates a gaming system in accordance with one embodiment of the invention; the gaming system including one or more gaming machines;

FIG. 3 illustrates one example of a winning bingo card pattern;

FIG. 4 illustrates various game ending bingo patterns in accordance with an example of the invention;

FIG. 5 illustrates interim game winning bingo patterns in accordance with an example of the invention;

FIGS. 6A and 6B illustrate an example of a paytable for a game including the winning bingo patterns illustrated in FIGS. 4 and 5;

FIG. 7 illustrates a display of a gaming machine configured to display reward information in accordance with an embodiment of the invention;

FIG. 8 illustrates a gaming system including gaming machines, the gaming system configured to generate, store and/or display reward information in accordance with the invention; and

FIG. 9 illustrates a flow of information between a gaming machine and a host of the system illustrated in FIG. 8.

### DETAILED DESCRIPTION OF THE INVENTION

The invention is a game, including a method of playing/presenting a game, methods for determining, awarding and representing game outcomes, including wins, and apparatus for presenting the methods of the invention. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is a method of playing/presenting a Class II game in which the outcome of the game is, at one or more times, represented as a secondary event, display or graphic. In general, all players of the Class II game play for the same set of outcomes, including the same set of winning outcomes. Each player's game characteristics, however, may vary. For example, players may place wagers of different amounts for the opportunity for different winning payouts and different winning payout frequencies. One embodiment of the invention is method of awarding payouts, such as in association with winning results and such as when the outcome is represented as one or more secondary events. In one embodiment, a plurality of different types of winning results or awards, preferably comprising either or both of a first or primary credit payout and a second or secondary credit payout, are associated with the winning outcomes. This aspect of the invention has applicability to a variety of games.

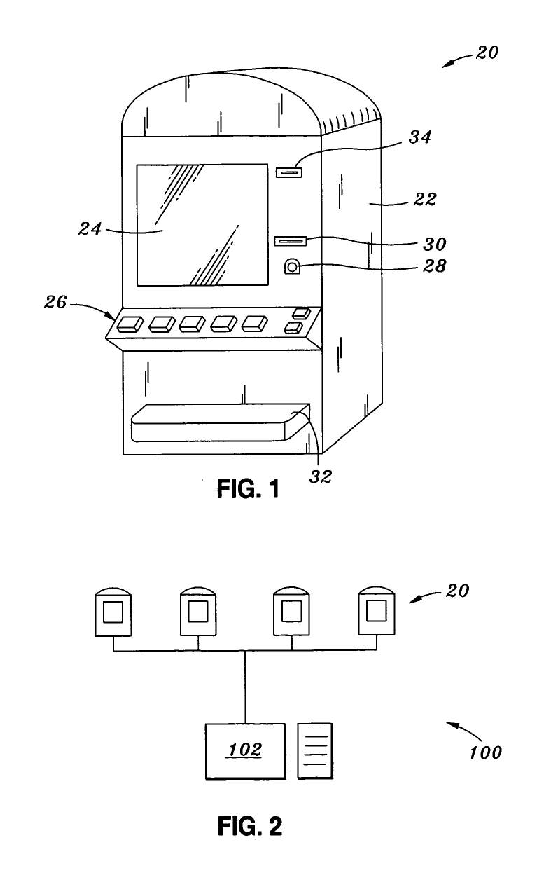

The various methods of the invention may be presented on or by a gaming machine. The gaming machine may have a variety of configurations. One embodiment of a gaming machine is illustrated in FIG. 1.

As illustrated therein, the gaming device or machine 20 includes a housing 22 containing or supporting various components. The gaming machine or device 20 is, either alone or in combination with other devices, preferably configured to present a game, such as a game of the invention. It will be appreciated that the housing 22 may have a variety of shapes and configurations. For example, the gaming machine 20 may be configured as an “upright,” “bar-top” or “slant” style gaming machine, which configurations are well known in the industry.

As illustrated, the gaming machine 20 includes means for displaying symbols or indicia utilized in the play or presentation of a game. In a preferred embodiment, the gaming machine 20 is configured as a “video” type machine, in which game information is displayed on at least one display 24. In a preferred embodiment, the display 24 is a video display. The display may be of a variety of types now known or later developed, such as DLP, CRT, plasma, LCD or others.

The gaming machine 20 preferably includes one or more player inputs which permit the player to interact with the gaming machine 20. In the embodiment illustrated, the gaming machine 20 includes a plurality of push-buttons 26. The function to which each button is linked may vary, depending at least in part upon the particular game which the machine 20 is presenting or is configured to present. For example, as described below, the buttons 26 might include a “play” button, a “bet one” button, a “bet max” button, and a “cash out” button, among others.

A wide variety of other inputs may be provided, varying both in form and function. For example, in one embodiment, the display may be configured as a “touch screen” type display. Other inputs, such as a rotatable arm, joysticks, keyboards or keypads, or other inputs may be provided. Each input preferably provides input, such as by way of an electrical signal, to the gaming controller or other game content generating device. In that manner, game play is interactive.

In one embodiment, the gaming machine 20 is configured to present a game only upon a player placing a bet, wager, or other payment. Thus, the gaming machine 20 may include means for accepting value, and preferably, monetary value. As illustrated, the gaming machine 20 may include a coin acceptor 28. The coin acceptor 28 may be configured to accept coins of one or more denominations. A coin sorter, coin hopper and other coin holding and processing devices may be located in the housing 22 of the gaming machine 20.

The gaming machine 20 may also or alternatively include a bill validator 30. The bill validator 30 may be configured to accept paper money of one or more denominations. A bill stacker and other bill processing and storage devices may be located in the housing 22 of the gaming machine 20.

The gaming machine 20 may also or alternatively include a ticket reader, smart card, credit card or other media acceptor/reader. Such devices may be utilized to obtain information regarding value, such as credit card account information or bar-coded ticket value. In one embodiment, the ticket reader may be combined with the bill validator 30.

When value is provided to the gaming machine 20, the gaming machine 20 may be configured to display information regarding the provided value, such as in the form of “credit” information. This information may be displayed, for example, on a display of the gaming machine or one associated therewith.

The player may utilize inputs to place a wager, bet or provide payment to play a game. For example, a player may depress a “bet one” or “bet max” button to bet or wager one or more credits.

In one embodiment, the gaming machine 20 is configured to award winnings for winning outcomes of games played. The winnings may be paid or provided to the player in a variety of manners. In one embodiment, awards may be indicated in the form of credits. Thus, when a player wins, the total number of credits belonging to them is increased, and the increased amount may be displayed to the player. The player may utilize the awarded credits to play future games.

In another embodiment, the player may be awarded money, or may convert credits to money. As illustrated, the gaming machine 20 may include a coin tray 32 into which coins may be dispensed. The coins may represent a specific award. Alternatively, the player may utilize a “cash out” button or input and be paid the value of their credits in the form of coins.

Other forms of payment may be provided, such as by issuance of a ticket which represents value. As illustrated, the gaming machine 20 includes a ticket printer 34 for printing and dispensing a medium bearing information regarding value.

Preferably, means are provided for controlling the operation of the gaming machine 20, such as the content displayed by the display 24. In one embodiment, that means comprises a gaming controller. The gaming controller may be configured to track game credits (including value provided to the gaming machine and bets placed), generate and/or display game symbols or indicia and determine game outcomes. In one embodiment, a gaming controller includes a processor and a memory. The memory stores software which is executed by the processor. In one embodiment, the gaming controller is located inside of the housing 22 of the gaming machine 20.

The gaming machine 20 illustrated and described is just one embodiment of a device which may be used to present a game in accordance with the invention. Other devices may be utilized. For example, the gaming machine 20 may also comprise a computing device, such as a laptop or desktop computer. Game information may be transmitted via a communication link to a remote player. The communication link may include, for example, the Internet. The game information may be utilized by the remote player's computer, such as by displaying game information on an associated screen. A player may provide input via a keyboard, mouse or other input device.

As described below, in one embodiment, the gaming machine 20 is configured to present a Class II game, and more particularly a bingo game having one or more results displayed as one or more secondary events, such as a Class III game-type event. In one embodiment, the bingo game information is displayed on the display 24, as is the Class III-type result event. For example, a result of the Class II game may be displayed as a secondary graphic on the display 24.

In another embodiment, the gaming machine 20 could include one or more mechanical reels comprising bodies having one or more indicia or symbols printed thereon for displaying game information. For example, those reels may be used to display the Class III type event comprising the result of the Class II game. The reels may have a number of positions or locations which bear or do not bear (i.e. comprise a “blank” position) indicia. The indicia or symbols which are borne by the reels may vary.

In such a configuration, means are provided for rotating the reels. In one or more embodiments, the means may comprise motors which are arranged to rotate and stop each reel. Such mechanisms are well known to those of skill in the art. Preferably, a controller is arranged to either turn off the signal to the device(s) effecting the rotation of each or all of the reels or generates a signal for activating a braking device, whereby the reels are stopped. The controller is arranged to stop the reels in a position displaying a combination of indicia as determined by the controller which corresponds to the outcome of the Class II game. The principal of such an arrangement is described in U.S. Pat. No. 4,448,419 to Telnaes, which is incorporated herein by reference.

In other embodiments, the gaming machine 20 may include multiple video displays or other display devices such as rotating wheels, meters and other elements for conveying information regarding one or more aspects of the game. For example, a first video display may display primary game information, while a second display may display the secondary event(s).

As indicated, in a preferred embodiment, the gaming machine 20 is configured to present a Class II game and, more particularly, a bingo-based game. As indicated, to meet certain laws/requirements, in such a configuration, multiple players must elect to participate in order to the game to be presented. In one embodiment, games are presented to multiple players by two or more associated gaming machines.

Referring to FIG. 2, in one embodiment, a gaming system 100 includes at least two gaming machines 20. In one embodiment, the operation of each gaming machine 20 is controlled in whole or in part from a remote location, such as a remote server 102. For example, game data may be generated remotely and be transmitted to the gaming machine 20 for display. The game data may then be downloaded to the gaming machine 20 via a wired or wireless communication link.

In such a configuration, when a player wishes to play a game at a gaming machine, the gaming machine sends a signal to the server 102. If there are least two such signals indicating at least two players desire to play, then the server 102 may be configured to initiate the presentation of the game. In the course of presenting the game, the server 102 may create game data which is transmitted to the gaming machines 20 for use by the gaming machines 20 in presenting the game. Such a configuration of a distributed gaming system are well known.

Of course, the gaming machines and the gaming system may have a variety of other embodiments. For example, the gaming machines might comprise computing devices and the system might include a LAN, WAN, dedicated communication links, and even include the Internet. For example, the game might be presented to a plurality of user of home computing devices which communicate with a remote server via the Internet.

In one embodiment, multiple servers may communicate with one another via one or more communication links. In this manner, multiple gaming machines at a first location may be associated with multiple gaming machines at a second, remote location.

One embodiment of the invention is a method of game play including presenting a game and the results thereof. This method may be implemented on a gaming machine/system such as that described above, among other environments.

One embodiment of the invention is a game. Preferably, the game meets the definition of a Class II game. In one embodiment, the game is a multi-player game, and more particularly, the game of bingo. The multi-player game of bingo is well known and thus will not be described in great detail herein.

In accordance with the game, each player preferably places a wager to be entitled to play the game. In one embodiment, the wager comprises one or more credits. Preferably, as described below, different game outcomes, including awards, may result depending upon the size of the player's wager.

Each participating player is provided with a set of player symbols, such as numbers. In a preferred embodiment, the symbols are associated with a game card. In one embodiment, the game card is a bingo card having spaces bearing symbols such as numbers. In a gaming environment where the game is presented on an electronic gaming machine such as that described above, the game card is preferably electronically displayed.

Game numbers (or other symbols, when the cards bear other symbols) are drawn. In a preferred embodiment, the game numbers are randomly selected, such as by a random number generator (RNG) associated with a server. As is known, the object of the game is for the player to match game numbers and/or symbols to the numbers and/or symbols on their card(s) to achieve a pattern. The numbers may be drawn or generated one at a time, or in groups or sets containing one or more numbers.

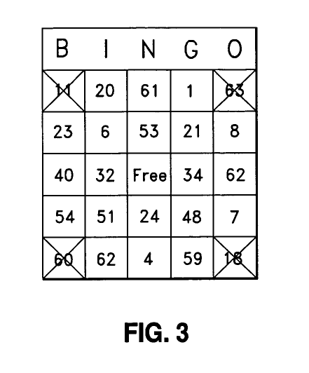

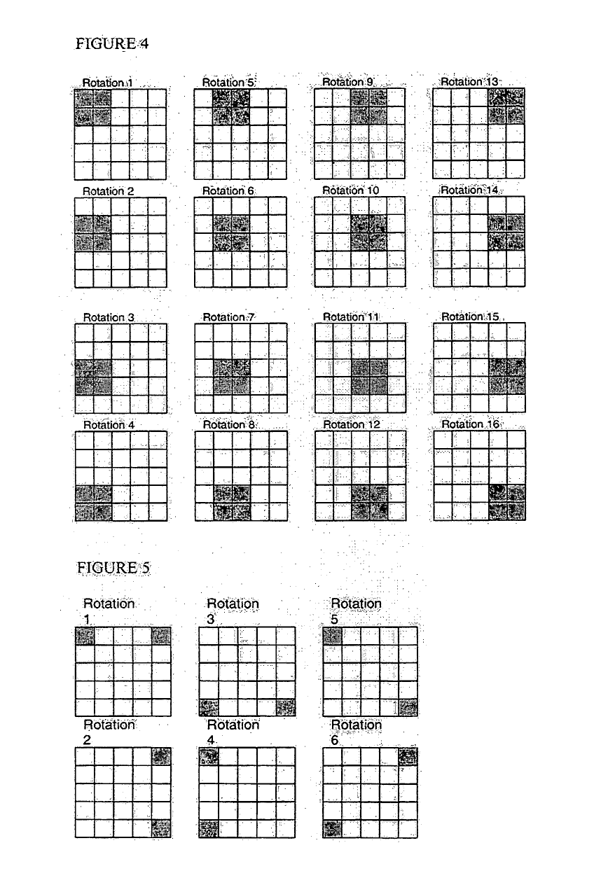

One or more patterns of matching numbers or symbols are designated game winning combinations. For example, a game winning patterns may be one or more of those illustrated in FIG. 3, such as “four corners,” “cover-all,” “a diagonal” or others.

As game numbers are drawn, the object is to match the game numbers to numbers on the game cards. In one embodiment, the game numbers are displayed to the players. For example, the game numbers may be transmitted from the server to the gaming machines and displayed on the displays thereof.

As is known, the game numbers may be selected in a variety of fashions. Of course, in a traditional manner, the numbers may be printed on balls, and the balls may be randomly drawn. In an electronic game environment such as that illustrated in FIG. 2, the numbers may be selected with a random number generator of the server 102.

In one embodiment of the game, a player is required to daub matching numbers. This may be performed manually, such as by a player touching an area of a display corresponding to the card location of a number match, or by the player instructing the gaming machine to daub all matches (such as by selection of a “daub” button) on the machine. In one embodiment, the step of daubing results in a confirmation of a match and may include the display of the match on the player's game card.

As indicated above, the object of the game is for a player to achieve a predetermined matching card pattern. In one embodiment, the game must have a winner, game numbers are selected until at least one player has achieved a predetermined winning combination.

In accordance with the invention, the result of the game are represented or displayed as one or more secondary events, displays or graphics. The secondary event may simulated or comprise a gaming type event, such as the spinning of a roulette wheel, a blackjack game, a video poker game, a slot-type graphic, a craps or other dice event, a simulated horse or dog race, or other types of gaming events now known or later developed. In one embodiment, the secondary event may comprise other types of events, such as various forms of exciting graphic displays.

In one embodiment, each player's game outcome is represented as such as event, whether the outcome is a winning or losing outcome. In another embodiment, only winning outcomes might be displayed as such an event.

In one embodiment, the outcome of the game is displayed or represented as a slot-type graphic, display or event, i.e. has the appearance of a Class III slot-type game. This preferably comprises the display of a plurality of symbols. Preferably, the symbols are displayed on mechanical or video-simulated reels. As is known in the game of slots, the outcome of the game is determined by combinations of symbols which are displayed at the end of the event (such as when the reels stop rotating). In one embodiment, a plurality of symbols are displayed, but only those symbols which are positioned along “paylines” are those which define the result of the event. For example, a payline may comprise a horizontal line extending through or across three reels displaying symbols. There may be more than one payline (as described below) and the configuration of the paylines may vary (for example, they may be “V” shaped, diagonal, vertical, horizontal or other variations).

In this arrangement, the particular secondary event, display or graphic which is displayed is known from the outcome of the base game, with the outcome of the base game simply represented by or including the second event. Thus, in one embodiment, possible secondary events, displays or graphics are mapped to outcomes of the base game. For example, if a “cover all” bingo result is designated a winning event, then that result may be represented by a slot graphic of the symbols “7-7-7” displayed on an active payline.

One embodiment of the invention is a method for determining awards for winning outcomes and for representing outcomes as secondary events, such as the outcome of a simulated game. This aspect of the invention has particular applicability to the above-described method of game play. As described below, however, this aspect of the game may be applied to a variety of games or gaming environments.

In accordance with the invention, one or more of the potential outcomes of the bingo game are designated winning outcomes. In a preferred embodiment of the invention, an award is associated with each winning outcome. The particular award associated with each winning outcome, however, may vary. In one embodiment, the award associated with each winning outcome varies depending on one or more criteria. In a preferred embodiment, the criteria includes the size of the player's wager.

One aspect of the invention is a game in which at least two different types of awards are associated with one or more of the winning outcomes. The particular types of awards may vary depending upon criteria such as the size of the player's wager.

In one embodiment, the types of awards include, but are not limited to, awards of credits of a first or primary type, and of a second or secondary type. The primary credits may be credits of the same value or denomination as the player's wager. The secondary credits may be credits having a different value or denomination as the primary credits. In one embodiment, the secondary credits have a lesser value or denomination than the primary credit. For example, the secondary credits may have a value of 1/100th of the value of a primary credit, and thus may be referred to in one embodiment as “fractional” credits.

As indicated, either or both types of awards are preferably associated with each winning combination. In a preferred embodiment, the award which is associated with each winning combination or outcome is selected so that the outcomes of the game may be represented as a secondary display, graphic or event. Where the secondary graphic is of a game, the particular secondary graphic or display which is displayed may be based upon the representative odds of receiving winning and losing combinations for the game being represented, and including changes in awards based upon the size of a player's wager.

An example of the method and configuration just described will be described in detail with reference to Table 2.

TABLE II

| Bingo | | Primary Credit Award | |
|---|---|---|---|
| Pattern | Secondary Credit Award | 1 Credit Wager | 2 Credit Wager |
| 1 | 100 | 200 | 400 |
| 2 | 95 | 0 | 100 |
| 3 | 90 | 0 | 0 |
| 4 | 85 | 50 | 50 |
| 5 | 80 | 0 | 20 |
| 6 | 75 | 0 | 0 |
| 7 | 70 | 10 | 10 |
| 8 | 65 | 0 | 5 |
| 9 | 60 | 0 | 0 |
| 10 | 55 | 2 | 4 |
| 11 | 50 | 0 | 2 |
| 12 | 45 | 0 | 0 |
| Must Go | 40 | 0 | 0 |

Table 2 illustrates a mapping of two types of awards to winning outcomes of the games. As illustrated, each and every player of the game plays for the same winning outcomes (bingo patterns 1-12 or “Must Go,” which in one embodiment is a pattern which must be received to win the game if patterns 1-12 are not received within parameters set for those patterns, such as a winning cover before a certain maximum number of game numbers are selected). However, the awards which are associated with those winning outcomes varies, in this instance, based upon the size of the player's wager.

As illustrated, in a preferred embodiment, a winning or award is associated with and awarded to a player who receives any of the winning bingo patterns or outcomes. Preferably, however, the award which is associated with one or more of the winning outcomes varies depending upon game play criteria, such as, in this instance, the size of the player's wager.

In one embodiment, a secondary credit award is associated with each and every winning outcome, no matter the size of the player's wager. In this regard, all players are playing for the same winning combinations or outcomes, regardless of the size of their wager, since all players are awarded winnings for those outcomes, regardless of the size of their wager.

In this example, the size of the secondary credit award for each winning outcome is the same regardless of the size of the player's wager. In another embodiment, the size of the secondary credit award may vary. In one embodiment, only a primary credit award might be associated with a winning outcome (for example, no secondary credit award might be associated with Bingo Pattern 1 of Table II, since a primary credit award is associated with that winning outcome as to all types of player wagers—in other words that outcome is winning outcome as to all player by virtue of the existence of the primary credit award).

In this example, a player may also be awarded an award of primary credits, depending upon the particular winning outcome and/or the size of the player's wager. For example, if a player placed a wager of a single credit and obtained a game outcome comprising bingo card pattern 1, then the player is awarded 200 primary credits. However, if a player obtained the same winning outcome having wagered a larger wager, such as two credits, then the player is awarded 400 primary credits. On the other hand, if the player had received bingo card pattern 2 and placed only a single credit wager, they would have been awarded no primary credits. If the player had placed a two credit wager, they would have been awarded 100 primary credits.

As illustrated, the winning outcome in each instance is still preferably represented by a secondary event comprising a slot-type display or graphic. Thus, each outcome of the game preferably corresponds to a representative secondary event outcome. For example, with reference to Table II, the payout or award of 200 primary credits (for a 1 credit wager when bingo pattern 1 is received) might be represented as the set of symbols 7-7-7 on a payline. The payout or award of 400 credits (for a 2 credit wager when bingo pattern 2 is received) might be represented as the symbols Cherry-Cherry-Cherry on a payline.

Preferably, the number of winning bingo patterns, the primary and secondary credit awards, and the associated event representations, are selected so that the outcomes of the bingo game may be realistically represented as a secondary event or display, and most preferably a secondary game display or graphic. As described below, in one embodiment, the selection of the awards, and preferably the selection of the primary credit awards, is arranged, relative to the secondary events, so that the presentation of the secondary events mimics the actual play, including frequency of receiving secondary event outcomes which represent winning outcomes, and payouts, which mimic an actual game.

One example of a method of implementing the above-described aspect of the invention will now be described. First, a set of bingo patterns are selected as winning outcomes. The number of patterns selected is large enough to create various prize value/odds pairings necessary to allow the secondary event to be accurately reflected. It will be appreciated that the winning outcomes may be selected from a set of possible outcomes for the game.

Next, a secondary credit value is assigned to one or more, and preferably each, winning outcome. This permits calculation of a baseline payout for the game. In a preferred embodiment, the baseline payout resulting from secondary credit payouts is fairly low, such as <1% of the total prize payout. This allows the majority of the prize payout to be in the form of primary credits.

A set of primary credit awards, including their values, are selected. As indicated, the primary credit award may have a value of 0.

Winning bingo patterns are selected from the set of winning patterns and are paired with one or more primary credit awards in order to achieve the payout percentage/hit frequency requirement for that value of award in the paytable of the secondary event which represents the outcome of the game. The combinations of all selected individual patterns and prize values are selected so that the overall frequency of winning outcomes and the payout percentage of the game is known. If a winning outcome was not assigned a secondary credit award, then it is preferably ensured that a primary credit award is associated therewith, so that each winning outcome results in some type of award. It is noted that the combination of types of awards, such as primary and/or secondary credit values, may both vary based upon a player's wager (for example, as to one winning bingo pattern, a player placing a 1 credit wager might receive 10 secondary credits, while a player placing a 2 credit wager might receive 20 secondary credits and 20 primary credits).

In a preferred embodiment of the invention, the primary credit values or awards for winning game outcomes are mapped to one or more secondary event outcomes. This mapping is selected so that the various secondary events which represent the game outcome, have results which mimic or emulate a true game or event. For example, a non-winning game result providing a zero credit payout may be mapped to a normal non-winning result in of a secondary game display, such as Blank-Bar-Blank for slot-style displayed event or a non-winning video poker hand. A winning game outcome having a 10 credit payout may be mapped to one or more outcomes of a secondary game-type event display having the same frequency of occurrence and have similar payouts, such as Blank-Cherry-Blank or a “pair of Jacks or better” for video poker type game. Larger winning game outcome payouts may be mapped to game event displays which have a low frequency and traditionally higher payout. Preferably, of course, the various outcomes/payouts are mapped to the various secondary events or outcome displays so that the frequency of wins and associated payouts mimics the secondary event as if it were an actual game or true event.

The secondary credits may be similarly mapped to (or with) the primary credits. In another embodiment, when the secondary credit awards are provided for all winning outcomes, they may simply be awarded, such as by incrementing the credit meter.

One example will now be illustrated. This example assumes a simple game in which 12 bingo patterns have been selected as winning combinations. The table below shows the hit frequency for the bingo patterns and the resulting odds. The minimum number of players required to play the game is 2. The monetary value assigned to a secondary credit is 1/100th of a primary credit.

TABLE III

| | | |
|---|---|---|
| Secondary Unit | 0.01 | |
| per Primary Credit | 100 | |
| Minimum Players | 2 | |
| Bingo Pattern | Frequency | Odds |
| 1 | 0.001 | 1000 |
| 2 | 0.001 | 1000 |
| 3 | 0.001 | 1000 |
| 4 | 0.005 | 200 |
| 5 | 0.005 | 200 |
| 6 | 0.005 | 200 |
| 7 | 0.02 | 50 |
| 8 | 0.02 | 50 |
| 9 | 0.02 | 50 |
| 10 | 0.1 | 10 |
| 11 | 0.1 | 10 |
| 12 | 0.1 | 10 |
| MustGo | 0.311 | 3.2154 |
| Total Game Hit Freg | 0.378 | |
| Spins/Prize Pay | 2.65 | |

In Table IV, 4 of the winning bingo patterns are additionally assigned additional primary credit awards. The resulting hit frequency (1 in 7.94 spins) and percentage of prize payout (85%) of the primary credit prizes is similar to 1 line in play on a 3 reel 3 line slot display.

TABLE IV

| | Payline1 | Credits | 1 | |
|---|---|---|---|---|
| Bingo | Credit Pay | Prize | Reward Cont | Hit Freg |
| 1 | 200 | 0.2 | 0.00001 | 0.001 |
| 2 | 0 | 0 | 0.00001 | 0 |
| 3 | 0 | 0 | 0.00001 | 0 |
| 4 | 50 | 0.25 | 0.00005 | 0.005 |
| 5 | 0 | 0 | 0.00005 | 0 |
| 6 | 0 | 0 | 0.00005 | 0 |
| 7 | 10 | 0.2 | 0.0002 | 0.02 |
| 8 | 0 | 0 | 0.0002 | 0 |
| 9 | 0 | 0 | 0.0002 | 0 |
| 10 | 2 | 0.2 | 0.001 | 0.1 |
| 11 | 0 | 0 | 0.001 | 0 |
| 12 | 0 | 0 | 0.001 | 0 |
| MustGo | 0 | 0 | 0.00311 | 0 |
| | Totals | 85.0% | 0.69% | 0.126 |
| | Net Payout | 85.7% | Spins/ReelPay | 7.94 |

In accordance with Table V, 8 of the winning bingo patterns have been assigned additional primary credit awards. The resulting hit frequency (1 in 3.97 spins) and percentage of prize payout (87.5%) of the primary credit awards is similar to 2 lines in play on a 3 reel 3 line slot display. The higher payout percentage would be represented by additional payout features that resulted when the player elected to play the second line on the slot display (at a higher resulting wager of 2 credits).

TABLE V:

| | Payline2 | Credits | 2 | |
|---|---|---|---|---|
| Bingo | Pays | Prize | Reward Cont | Reel Hit |
| 1 | 400 | 0.2 | 0.00001 | 0.001 |
| 2 | 100 | 0.05 | 0.00001 | 0.001 |
| 3 | 0 | 0 | 0.00001 | 0 |
| 4 | 50 | 0.125 | 0.00005 | 0.005 |
| 5 | 20 | 0.05 | 0.00005 | 0.005 |
| 6 | 0 | 0 | 0.00005 | 0 |
| 7 | 10 | 0.1 | 0.0002 | 0.02 |
| 8 | 5 | 0.05 | 0.0002 | 0.02 |
| 9 | 0 | 0 | 0.0002 | 0 |
| 10 | 4 | 0.2 | 0.001 | 0.1 |
| 11 | 2 | 0.1 | 0.001 | 0.1 |
| 12 | 0 | 0 | 0.001 | 0 |
| MustGo | 0 | 0 | 0.00311 | 0 |
| | Totals | 87.50% | 0.69% | 0.252 |
| | Net Payout | 88.2% | Spins/ReelPay | 3.97 |

In Table VI, all 12 of the winning bingo patterns have been assigned additional primary credit awards. The resulting hit frequency (1 in 2.65 spins) and percentage of prize payout (89.0%) of the primary credit awards is similar to 3 lines in play on a 3 reel 3 line slot display. The higher payout percentage would be represented by additional payout features that resulted when the player elected to play the second line on the slot display (at a higher resulting wager of 3 credits).

TABLE VI:

| | Payline3 | Credits | 3 | |
|---|---|---|---|---|
| Bingo | Pays | Prize | Reward Cont | Reel Hit |
| 1 | 500 | 0.166666 | 0.00001 | 0.001 |
| 2 | 250 | 0.083333 | 0.00001 | 0.001 |
| 3 | 100 | 0.033333 | 0.00001 | 0.001 |
| 4 | 50 | 0.083333 | 0.00005 | 0.005 |
| 5 | 30 | 0.05 | 0.00005 | 0.005 |
| 6 | 20 | 0.033333 | 0.00005 | 0.005 |
| 7 | 10 | 0.066666 | 0.0002 | 0.02 |
| 8 | 5 | 0.033333 | 0.0002 | 0.02 |
| 9 | 5 | 0.033333 | 0.0002 | 0.02 |
| 10 | 4 | 0.133333 | 0.001 | 0.1 |
| 11 | 3 | 0.1 | 0.001 | 0.1 |
| 12 | 2 | 0.066666 | 0.001 | 0.1 |
| MustGo | 0 | 0 | 0.00311 | 0 |
| | Totals | 0.883 | 0.0069 | 0.378 |
| | Net | 89.0% | Spins/ReelPay | 2.65 |

It will thus be understood how winning bingo patterns and their associated awards are selected so correspond to secondary displays, graphics or events which mimic the outcomes of the event being represented, such as a game of slots. In other words, secondary displays such as video poker games, slot-type games and other events, can be effectively modeled, when considering the normal winning and losing outcomes and payout for winning outcomes, for that games, from the outcomes of a different game (such as a Class II bingo game).

In one embodiment, the award is displayed to the player. For example, the number of secondary and, if awarded, primary credits, which a player is awarded are preferably displayed via a credit count or other display.

As indicated, the primary and/or secondary credits or other awards may have various characteristics. For example, both the primary and secondary credits may have associated monetary value, such as by being equivalent to a denomination of wager/credit, or portion thereof. For example, on a gaming machine where the base wager is $0.25, each primary credit may represent $0.25. In an embodiment where the secondary credits represent a portion of the value of a primary credit, each secondary credit might represent $0.0025.

In one embodiment, secondary credits might accrue until they reach a value of a primary credit or other value. For example, once a player accrues 100 secondary credits, those credits might be turned into a single primary credit which the player can then wager or cash out.

In one embodiment, the secondary credit accrual might be displayed as a running numerical total. Displays, such as graphs or other entertaining displays such as a thermometer, filling bucket or the like might be used to graphically display the accruing secondary credits.

In one embodiment, secondary credits which can not be “cashed out” may remain associated with the gaming machine and be usable by the next player of the gaming machine.

In one embodiment, the secondary credits might have other values. For example, the secondary credits might comprise points or represent points. A player might use the points to obtain various types of awards. For example, a player might win 1500 secondary credits. The player might obtain a ticket for those credits from the machine (such as via the ticket printer 34 of the machine 20 illustrated in FIG. 1), or those credits might be associated with a player club account. The player might then use those credits in order to obtain non-gaming goods and services, meals, lodging or the like, or discounts for such goods or services. In fact, the primary, secondary or any of the awards or winnings may be associated with a variety of types of media, such as cards, tickets or the like. They might also be virtually represented, such as with a credit meter, and be stored as data on the gaming network.

In one embodiment, certain of the awards, such as the secondary credits, may be used to participate in other events. For example, if a player accrues a certain number of secondary credits, the player may utilize those credits to participate in an additional event, such as a bonus game.

In one embodiment of the invention, the game may include one or more progressive awards. In such an arrangement, an amount of primary and/or secondary credits may be accrued. In one embodiment, the number of primary and/or secondary credits comprising the progressive award may be incremented based upon the number and/or size of player wagers to play the game. A variety of criteria may be applied for determining the winner of the progressive award. For example, a player who receives a particular winning game outcome may win the award. In one embodiment, a player who receives a particular winning game outcome, such as a particular bingo pattern, and has accrued a certain minimum number of secondary credits, may be eligible to win the progressive award.

In one embodiment, more than two different types of awards may be associated with the various winning outcomes. For example, first, second and third types of awards might be associated with the various winning outcomes. Preferably, at least one award is associated with each winning outcome as to all players of the game. Other awards may be associated with the winning outcomes to differentiate the awards as to various play characteristics, such as the size of the player's wager. Each of the awards may have different characteristics, such as different values.

The game of the invention has particular applicability to presentation of a Class II bingo game, and representation of the outcomes thereof as a secondary display, graphic or event. As indicated, the method of the invention allows for the secondary event, display or graphic to be of various types. It is also noted that while the base game preferably comprise Class II games, such as the game of bingo, pull-tabs or lottery events, but may comprise other games or events.

It is known that the nature of a Class II game such as a game of bingo is that the varying number of game numbers (such as associated with balls) or variations in player count can influence the frequency with which winning outcomes are received. The present invention permits primary credits (which comprise the majority of the awarded win value) to be mapped to or associated with those patterns which are least influenced by player count or game number variation. The remaining winning outcomes can then be assigned secondary credit awards. Since the secondary credits may only represent a small fraction of the overall game payout, such variation then have little affect upon the payout outcome of the game.

A variety of advantages and features of the invention will now be appreciated. In accordance with the invention all players of a game play for the same winning outcomes, regardless of the size of their wager. In this regard, an award or winning is associated with each an every winning outcome. However, the particular award which is associated with each winning outcome is preferably varied depending upon game play criteria such as the size of the player's wager. As indicated, the various outcomes and their associated awards are selected and mapped to secondary event outcomes so that when the outcome of the game is represented by the secondary events, the secondary events have probabilities of occurring which mimic those of an actual game.

In accordance with the invention, primary and secondary credit awards (or one or more other types of awards) are associated with the winning outcomes of the game. The secondary credit awards are associated with each winning outcome. However, the value of the secondary credits is reduced. In this manner, a baseline winning payout for the game remains very low. On the other hand, primary credits are used to distribute the bulk of the total game winnings. In this manner, the primary credits can be effectively used to control total payout percentages for the game and limit the majority of payment to certain outcomes, including outcomes which especially reward a player placing a larger wager.

It will be appreciated that various aspects of the invention have applicability to other types of games. For example, the method of the invention whereby multiple types of awards are associated with the outcomes of the game, may be applied to Class III games. For example, in a video poker game, all players may receive an award of secondary credits for winning outcomes. However, depending upon the size of the player's wager, a player may also receive a primary credit award for a particular winning outcome.

One advantage and aspect of the invention is the awarding of secondary or other awards which may be used to entice game play and build player loyalty. For example, in the method of game play described above, a player is rewarded secondary credits for their game play. As indicated, those credits may accrue, and even be saved. In such a configuration, players are enticed to play a plurality of games to accrue sufficient numbers of secondary credits to obtain an award.

Another embodiment of the invention having the above-stated advantages will now be described. In one embodiment, the awards which are associated with winning outcomes may be in credits having a single value (rather than differentiated primary and secondary credits, as described above). Once again, in accordance with the invention, each player of a game preferably plays for the same winning outcomes (such as bingo patterns). The awards associated with those outcomes, including the size of the awards, may vary, however, including as dependent upon the size of the player's wager.

In one embodiment, the primary and secondary credits values may be ‘scaled’ so that the awards for winning combinations are indicated in the form of a single value. For example, if a primary credit has a value of $1.00 and secondary credit has a value of $0.01, then awards of primary credits could be represented as 100 secondary credits. In this fashion, awards are represented as the number of secondary credits which are awarded.

One example will now be described. This example is of a game of bingo. As described above, the various principles of the invention may be applied to a wide variety of games. In this example, each player plays for either a game ending bingo pattern or an interim winning pattern. If a player of the game receives a game ending pattern, then the game ends and the player is awarded the associated award for that pattern. If a player receives an interim winning pattern, the game continues until a game ending pattern is received by a player of the game. If a player receives one or more interim and/or winning patterns, then the player is preferably awarded the highest individual prize for those outcomes. Of course, the game may be played or presented with other variations.

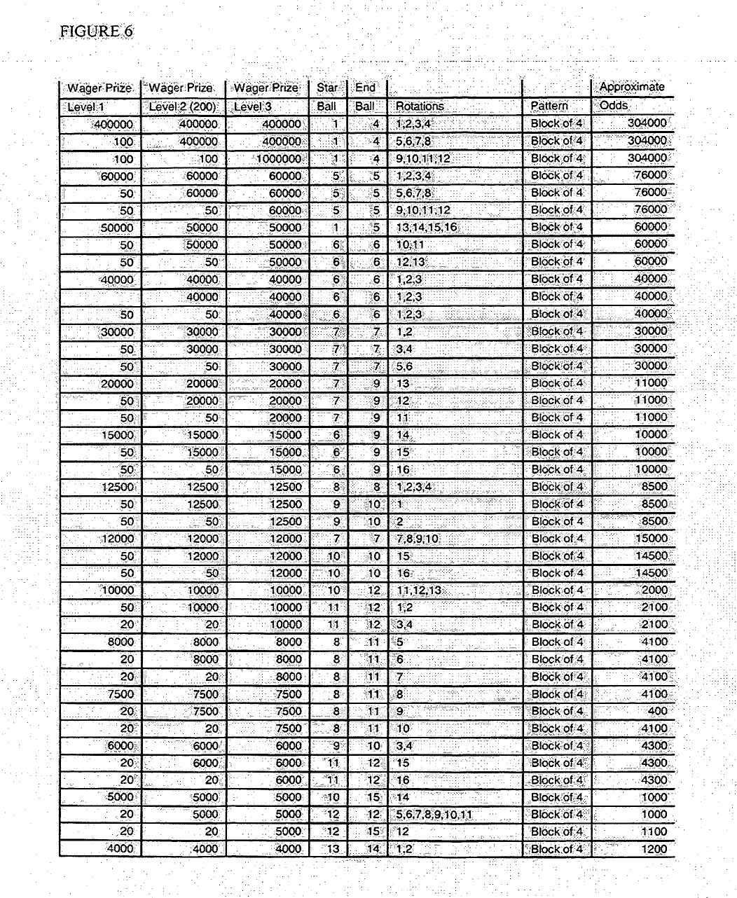

As indicated, each of the players of the game play for the same winning outcomes, preferably including game winning patterns and interim winning patterns. As one example, the patterns illustrated in FIG. 4 may be game winning patterns. The patterns illustrated in FIG. 5 may be interim winning patterns.

In accordance with the invention, the size of the award associated with each winning outcome is dependent upon one or more criteria. In one embodiment, this criteria includes which particular winning outcome is received, when the winning outcome was received (in term of how many bingo balls/game numbers were required in order to achieve the matching pattern) and, most preferably, the size of the player's wager.

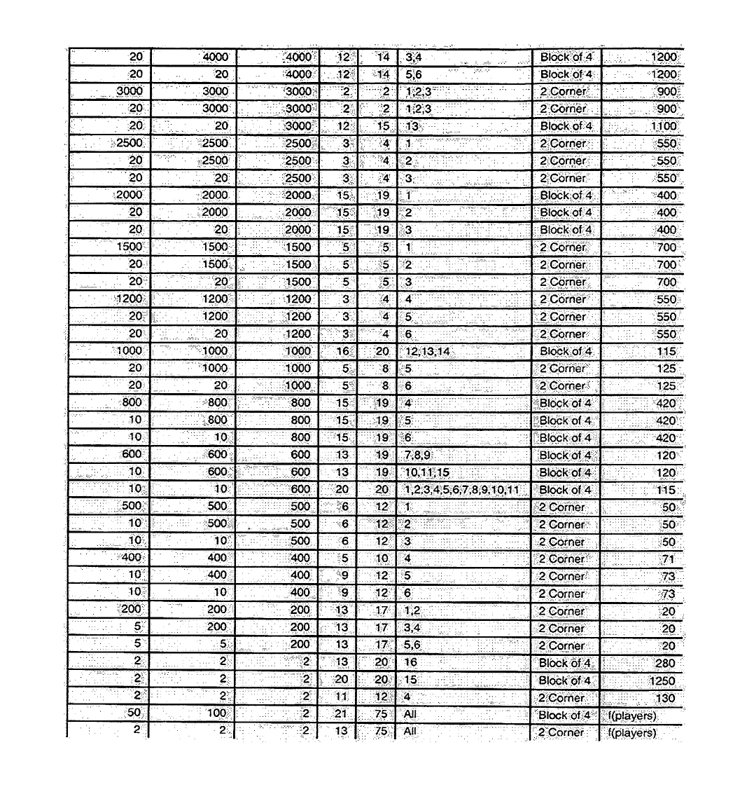

FIGS. 6A and 6B are a table illustrating one configuration of awards for such a game (in this figure, the term f(players) indicates that the odds of receiving the outcome is a simple function of the number of players of the game). As illustrated, a player may be permitted to place a wager of one of three amounts: a level one wager (such as a wager of $1.00), a level two wager (which is preferably two times the level one wager), and a level three wager (which is preferably three times the level one wager). In this embodiment, a primary credit is valued the same as a base or level one wager, and a secondary credit is valued at 1/100th of the primary credit. As such, when scaled, a primary credit and a base wager are equivalent to 100 secondary credits. All awards are then represented in terms of the number of secondary credits. Of course, there might be a greater or lesser number of levels or amounts of wagers which are permitted.

In accordance with the invention as described, the outcome of the game may be represented or displayed in a variety of fashions. In one embodiment, the outcome of the game is represented by a secondary event if the size of the award is above a predetermined threshold. For example, if the award is less than 200 credits, the result of the game may simply be represented by the displayed bingo card matching pattern. If the award exceeds 200 credits, the result of the game may be displayed as one of the potential outcomes of a secondary event such as described above.

As with the various embodiments described above, the size of the various wagers which may be placed, the size/amount of the awards for various winning outcomes, and the size or value the credits which comprise the awards, may vary. In accordance with one aspect of the invention, awards associated with winning outcomes are represented by one or more credits, those credits having a value or denomination which is less than the value or denomination of placed wagers. As indicated above, the award credits may have a value of 1/100th of the denomination of a wager credit. However, in other embodiments, an award credit may have a value of 1/1000th, 1/10th, 1/25th or other values of the denomination or value of a wager credit. It will be appreciated that this arrangement permits a wide range of award values associated with the various outcomes, achieving the same effect as described above where the awards are represented by one or more of two or more different credits.

Another aspect of the invention is a gaming system, game and method of playing a game including the display of player rewards information. In accordance with one embodiment of the invention, player rewards such as credits or points and/or awards such as free game play, are displayed to a player, such as during game play. As will be described in more detail below, this aspect of the invention has applicability to a wide variety of games, gaming machine and systems including, but not limited to, the above-described method and apparatus for awarding wins for game play.

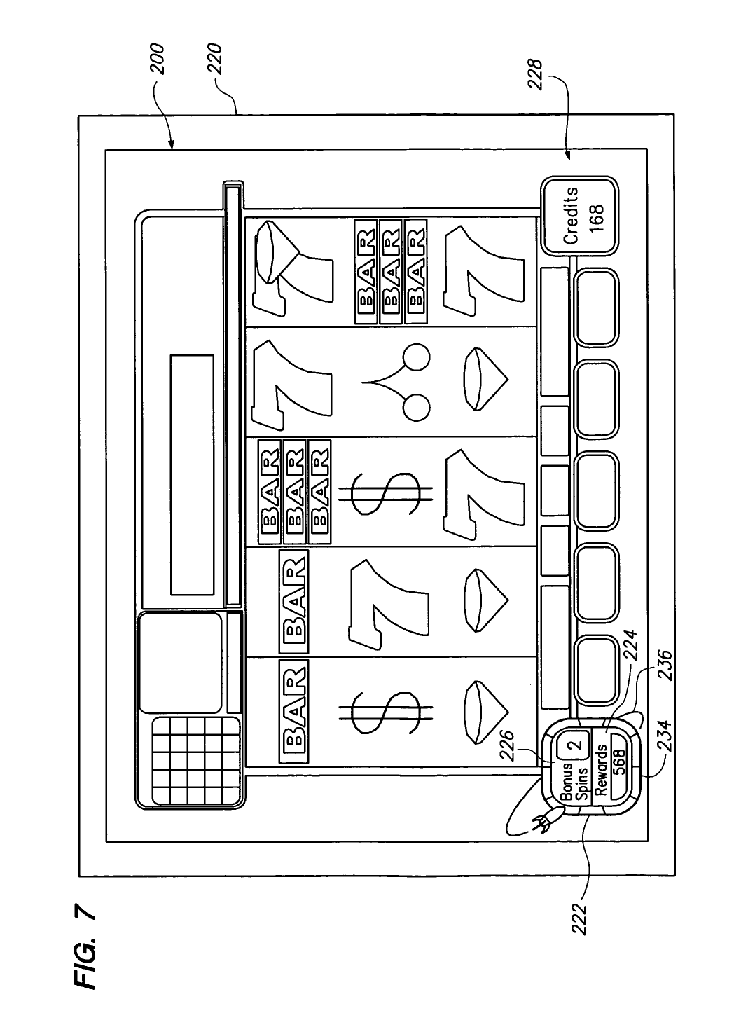

One embodiment of the invention will be described with reference to FIG. 7. FIG. 7 illustrates a display 200 of a gaming machine 220. The gaming machine 220 may be of a variety of types, as disclosed above. As illustrated, the display 200 is configured to display rewards information 222. As is known in the art, a gaming controller or other device may be configured to generate such information and provide that information to a display controller, thus causing the display device to display the desired information.

In one embodiment, the rewards information 222 comprises graphical and/or textual information which is displayed by the display 200. In one embodiment that information includes point or credit information 224 and rewards or awards 226 based upon accrued or awarded points or credits.

In one embodiment, a player may accrue points, credits or the like. The points or credits may be accrued via play of one or more games or other criteria. For example, as detailed above, in one embodiment of the invention, a player may be rewarded secondary credits for game play outcome. Points or credits may be yielded for other reasons or based upon other criteria. For example, a player may be awarded complimentary points or credits for each game played, regardless of the outcome (win or loss) of the games played. A player may also be awarded points or credits as “comps.” For example, for signing up for a player rewards club or purchasing goods or other services, the player may earn or be awarded points or credits. The number of points or credits which are awarded may vary depending upon a number of circumstances.

In one embodiment, the points or credits are preferably “reward” type, and are preferably separate or different from the monetary credits which belong to a player as a result of their providing value to the machine (such as coins, cash or credit), or the main or primary credits which are awarded for game wins. Thus, the gaming machine 220 is preferably configured to display not only the above-described reward points or credits 222, but also such monetary credits 228.

In a preferred embodiment of the invention, the player is provided information regarding a “value” of the awarded or accrued points or credits. In one embodiment, this “value” comprises earned awards or rewards 226. For example, as described above, in an embodiment where secondary credits are awarded as winnings for winning game play, numbers of those credits may have an equivalent value to primary credits which may be wagered to play a game. As such, the “value” of the accrued or awarded secondary credits may be represented as one or more earned primary credits or, in a preferred embodiment, a number of free games which may be played using the earned credits/points.

In one embodiment, for example, each secondary credit may have the value of 1/100th of a primary credit. If a maximum bet or wager to play the gaming machine is 10 primary credits, then 1000 secondary credits have the value of a single game maximum bet wager. As such, for each 1000 secondary credits or points which are accrued or awarded, an indication may be provided to the player that they are entitled to a free single maximum bet game or spin.

As the credits or points are accrued or awarded, they may be “converted” to representative awards which are then displayed to the player. In the example illustrated in FIG. 7, the player has received 2000 credits or points which have been converted into or are represented by an award of two free games. The player has also accrued an additional 568 points towards the next award.

In a preferred embodiment, the reward information 222 is displayed to a player during their game play, that information updated as points and/or awards are accrued. In this manner, the player is provided visual, real-time feedback of the results of their game play. For example, a player may have 400 points or credits, play a game, and obtain a winning result including an award of 50 primary credits and 100 secondary credits or points. The primary credit display is modified to reflect the player's winning of 50 primary credits. In addition, the reward information 222 is updated to reflect that the player has accrued 500 points.

In one embodiment, reward information is associated with a gaming machine 220. In such an embodiment, rewards are accrued and available for use by all players of the machine. If a first player plays a number of games and accrues rewards, such as sufficient points/credits for one or more free game awards, as illustrated in FIG. 7, that player may utilize the free game awards to play games without having to place a wager. Otherwise, the free game awards or earned credits/points remain associated with the machine, and the next player to play the machine may utilize the rewards.

In another embodiment, the reward information is associated with a player, such as via a player identification or tracking system. Such systems are well known to those of skill in the art. A player may have a player account and player information associated with that account. When a player desires to play a game, they may use player information, such as associated with a player card, to identify themselves. Accrued or awarded rewards may be associated with that player. In this manner, the player “keeps” all of the rewards which are awarded due to their game play. If a player has accrued rewards when they identify themselves at a gaming machine, the player's rewards may be transmitted to the gaming machine for display. Then additional rewards which accrue due to their game play at that machine may be associated with them.

In yet another embodiment, as described above, a player may also be issued a media with which the rewards information is associated. For example, a player may be issued a printed ticket or voucher having associated information (the media might also include a card, such as a magnetic stripe card or other types of media). That information may include reward information or information which identifies (such as a ticket code) the location of stored reward information. The player may be permitted to submit the media to another machine and have the reward information then associated with that machine. The rewards may be converted to a monetary or “credit” equivalent, or be posted as secondary rewards.

In one embodiment, the player may, as detailed above, “redeem” their rewards points or credits for non-gaming goods or services, or for discounted goods and services. The player may also be permitted to use their rewards points or credits in other types of gaming events. For example, a player may use their voucher as an entry to a secondary drawing. The number of “entries” may be based upon the number of rewards credits or points.

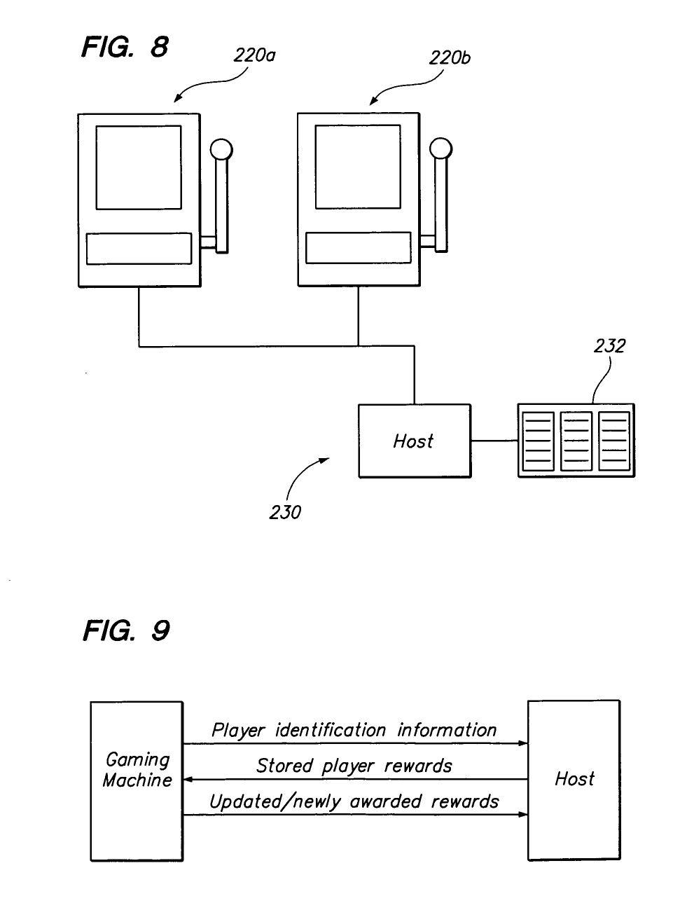

FIG. 8 illustrates one embodiment of a system including a plurality of gaming machines 220a, 220b, etc. associated with a host 230. The host 230 may be a server computer or other device or devices. The host 230 may be configured to perform a variety of functions. In one embodiment, the host 230 is configured to store information regarding one or more players in one or more player files 232.

FIG. 9 illustrates one embodiment of a flow of information between the gaming machines and the host of such a system. As illustrated, when a player identifies themselves at a gaming machine, player identification information is transmitted from the gaming machine to the host. The host then utilizes this player identification information to locate stored player reward information. Player reward information is then transmitted from the host to the gaming machine. That reward information is preferably then used by the gaming machine to display reward information as described above.

As a result of a player's activities at the gaming machine, such as the play or one or more games, the player may be awarded additional rewards. Alternatively, the player may utilize the rewards, such as by playing one or more free games. In those instances, the rewards are updated to reflect the changes. In one embodiment, the changes are reflected at the gaming machine and when the player stops playing, the updated totals/information is transmitted to the host. In another embodiment, any changes in rewards may be immediately transmitted from the gaming machine to the host, such that the host always maintains up to date reward information.

As indicated above, in one embodiment credits or points are represented by particular awards when sufficient credits or points exist to “convert” the credits or points to an award. In embodiment, an indicator may be provided to a player regarding how “close” they are to receiving another award. For example, in the embodiment illustrated in FIG. 7, a graphical display 234 provides information to this effect. As illustrated, the display 234 comprises a plurality of areas which may be illuminated. The number of areas which are illuminated at any given time is preferably in proportion to the number of credits or points accrued relative to the number necessary for an award. For example, ten areas may be provided. Areas may be successively illuminated as 100 credit/point increments are received, in the case where 1000 credits/points are necessary for an award.

Further, an indicator may be provided when credits or points have reached the plateau of an award. In one embodiment, the indicator is a graphical display 236, such as the appearance of a moving element. The indicator is preferably displayed only when the credit/point level is reached, thus informing the player that they have obtained another award. In one embodiment, for example, when a player reaches 1000 points/credits, the displayed number of points/credits is reset to zero (0), a rocket ship is displayed and “flies” around the reward information 222, and the number of awards, such as bonus spins/free games, is incremented by 1.

Of course, other indicators may be provided. These indicators may include sound or other types of visual information, such as lights or displayed textual information, among others.

As indicated, in one embodiment, points or credits which are accrued or awarded are associated with a player. As further indicated, this allows a player to move from one gaming machine to another and maintained their rewards. In one embodiment, the rewards or awards for particular credits or points may be automatically modified depending on the type of game or gaming machine being played. For example, a player may play a gaming machine were the minimum wager is $1.00 per game. In that instance, each credit or point may have a “value” of 1/100th of $1.00, or $0.01. While playing such a game, the player may accrue or be awarded 100 credits or points. If the player starts playing a game having a minimum wager of $0.25, the number of credits or points (or associated rewards) may be adjusted to reflect the relative “value” of the credits/points for a $1.00 wager game versus a $0.25 wager game. For example, if a player has 100 credits or points from play of a $1.00 game, then when the player switches to a $0.25 game, the number of credits/points may be multiplied by 4, to 400, to reflect that the credits or points earned from $1.00 play is 4 times greater than the “value” of similar points earned when playing a $0.25 wager game.

Similarly, if credits or points have already been “converted” to an award or reward, such an award or reward may similarly be adjusted. For example, if a player is entitled to one free game for each 1000 credits awarded, but the value of credits or points varies in proportion to the size of the wager to play a game, then the number of awards may be adjusted for games of different denominations or wager amounts. In the above-referenced example, if a player had accrued a free $1.00 wager game, then the player would be entitled to four (4) $0.25 wager games.

When a player changes machines, denominations or wager amounts, the credit/points and reward/award information may be adjusted.

A variety of award information may be displayed. In one embodiment, as detailed above, information regarding a number of free games or bonus spins is displayed. In other embodiments, other types of awards may be awarded and thus other information displayed. For example, a player may be awarded cash or other prizes. If a player receives 1000 points, for example, a player may receive “1 free meal” or another prize. The award information preferably comprises a numerical value of the number of awards or one or more types which have been accrued or awarded. However, other types of information might be displayed, such as prize level information or the like (e.g. “Prize Level A reached”), various prize levels having associated rewards or awards.

In one embodiment, if a player reaches a particular threshold of awards, the player may be awarded additional or different awards. For example, in the example detailed above, if a player receives a certain number of “free games/spins” then the player may be awarded one or more additional free games or spins. In this manner, a player is entice to play for a sufficient period of time to reach the threshold bonus.

As indicated, in one embodiment, points or credits are awarded or accrued. Preferably, those points or credits are represented by a numerical value. They might be represented in other fashions, however, such as solely by a graphical meter or other indicator of the level of points/credits accrued.

As indicated above, this aspect of the invention has particular utility to a version of a game and game play where secondary points or rewards are awarded as part of the “payout” for winning and/or losing game play. This aspect of the invention has applicability to a wide variety of other games and gaming systems, however. For example, in some instances players are awarded points or credits based upon amounts wagered in association with game play. For example, a player may be awarded a point for each $1.00 in wagers. In such an instance, the awarded points or credits may be displayed as the player plays games, with the points or credits accruing as the player places wagers to play games.

As indicated, this aspect of the invention may be implemented at a gaming machine including a display. This aspect of the invention may also be associated with games played at other than electronically controlled gaming machines. For example, points or credits may be awarded for a player's play of one or more table games. In one embodiment, point or credit information may be displayed at a display located at or associated with a gaming table.

In various embodiments, the reward information may be displayed with a separate display than that used to display game information. The display may be other than a CRT, LCD or similar display. For example, a simple LED numerical meter may be used to display the numerical value of the points and/or awards.

As indicated, the reward information is preferably continuously display or is displayed with relatively high frequency. In this manner, a “link” is maintained between the player's play and the rewards, thus reinforcing the “reward” associated with player play, enticing additional game play. In particular, by display of the reward information, the player can “see” increases in player rewards based upon game play or other activity. Indicators which alert the player to their reaching an award and to the “level” of closeness to an award are additionally useful in reinforcing reward for player's play and enticing continued play, aside from just the normal award of credits or monies. In this manner, this embodiment of the invention is an effective tool in promoting game play.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A method of game play comprising the steps of:
accepting a wager to play a game;
generating game data;
utilizing said generated game information to present a game to a player including displaying game information to a player;
determining the outcome of a game presented to a player;
awarding winnings to a player for a winning game outcome, said winnings including one or more primary credits and one or more secondary credits, said primary credits directly usable as a wager for playing a game and said secondary credits comprising reward credits; and
displaying reward information to said player, said reward information comprising information regarding a number of awarded secondary credits or a number of awards representative of a plurality of awarded secondary credits.

2. The method in accordance with claim 1 including the step of presenting a plurality of games to said player and wherein said step of displaying reward information includes displaying updated reward information based upon the outcomes of said plurality of games.

3. The method in accordance with claim 1 wherein information regarding a number of awards comprises information regarding a number of free games which the player is entitled to play.

4. The method in accordance with claim 1 wherein said secondary credits have a fractional value of said primary credits and awarded secondary credits are converted to free game awards based upon a value of said secondary credits to a value of said primary credits and the number of primary credits required to be wagered to play said game.

5. The method in accordance with claim 1 including the step of modifying said reward information if a denomination of wager placed by said player to play said game changes.

6. The method in accordance with claim 1 including the step of displaying a number of primary credits belonging to said player.

7. The method in accordance with claim 1 including the step of providing a visual indicator of a conversion of secondary credits to a representative award.

8. The method in accordance with claim 1 wherein said information regarding a number o awarded secondary credits comprises a numerical value and including the step of providing a visual indicator, other than said numerical value, of the number of secondary credits earned towards an award.

9. A method of presenting a plurality of games comprising:
accepting a wager of one or more credits for play of each game;
generating game information for each game;
presenting a plurality of games to a player using said game information;
determining an outcome of each game;
awarding a player one or more credits for winning outcomes of said games;
awarding a player one or more reward points; and
displaying during the play of said plurality of games reward information regarding the number of awarded rewards points or one or more awards representative of said awarded rewards points.

10. The method in accordance with claim 9 including the step of displaying information regarding a number of credits belonging to said player.

11. The method in accordance with claim 9 including the step of converting a first number of awarded rewards points to an award and decreasing a number of awarded rewards points by said first number.

12. The method in accordance with claim 11 including the step of providing a visual indicator in association with said converting step.

13. The method in accordance with claim 11 including the step of displaying a numerical value representing a number of rewards points and a numerical value of a number of awards.

14. The method in accordance with claim 9 wherein said credits relate to a wager denomination and including the step of modifying said reward information in said wager denomination changes.

15. A method of presenting a game comprising the steps of:
accepting a wager from each of at least two players to play said game, each wager comprising one or more credits of a first denomination;
designating at least one winning outcome for said game from a plurality of potential outcomes for said game;
associating an award with each winning outcome, the award associated with each winning outcome comprising one or more credits having a value of a second denomination which is a fraction of said first denomination, the award associated with each winning outcome varying depending upon a size of a wager placed by a player to play said game;
presenting said game to said at least two players, each player attempting to obtain a winning outcome for said game;
awarding to a player receiving a winning outcome said award associated therewith; and
displaying reward information regarding a number of awarded secondary credits or awards representative of awarded secondary credits.

16. The method in accordance with claim 15 including the step of accepting player identification information, identifying a player associated with said information and storing secondary credit or awards information in one or more files identifiable using said player identification information.

17. The method in accordance with claim 15 including aggregating awarding secondary credits or awards for play of multiple games.
